(19) United States
(12) Patent Application Publication
(10) Pub. No.: US 2019/0366631 A1
(43) Pub. Date: Dec. 5, 2019

(54) DEVICE FOR FORMING DIMENSIONALLY STABLE OBJECTS

(71) Applicant: WAY TO PRODUCTION GMBH, Wien (AT)

(72) Inventors: Thomas MICHALICA, Wr. Neudorf (AT); Simon GRUBER, Wien (AT)

(21) Appl. No.: 16/095,838

(22) PCT Filed: Apr. 19, 2017
(86) PCT No.: PCT/EP2017/059223

§ 371 Date: Oct. 23, 2018

(30) Foreign Application Priority Data
Apr. 25, 2016 (AT) A50363/2016

(51) Int. Cl. B29C 64/245; B33Y 30/00; B33Y 50/00; B29C 64/268; B29C 64/277; B29C 64/386

(52) U.S. Cl. CPC B29C 64/245; B33Y 30/00; B29C 64/386; B29C 64/268; B29C 64/277; B33Y 50/00

(57) ABSTRACT

The invention relates to a device for forming dimensionally stable objects through section-by-section solidification of a dimensionally unstable substance (3), in particular one that can be hardened by light, by means of exposure to radiation from a radiator (4), in particular an electromagnetic radiator, comprising a trough (2) for receiving the substance (3) as well as a construction platform (1) which is arranged above the trough (2) and can be lowered and lifted with respect to the trough for adhering to and lifting solidified substance layers (5), at least one light source (6) and at least one light sensor (7) detecting the light of the light source (6) being arranged in the area of the bottom of the trough (2) in such a way that a deformation of the trough (2) can be detected by changing the light intensity of the light source (6) detected by the light sensor (7).

The invention relates to a device for forming dimensionally stable objects through section-by-section solidification of a dimensionally unstable substance, in particular one that can be hardened by light, by means of exposure to radiation from a radiator, in particular an electromagnetic radiator, comprising a trough for receiving the substance as well as a construction platform which is arranged above the trough and can be lowered and lifted with respect to the trough for adhering to and lifting layers of solidified substance.

Devices of this kind are known from prior art. The dimensionally unstable substance (for example a plastic monomer) is located in a trough having a transparent bottom. The construction platform is arranged parallel to the bottom of the trough and can be displaced in a plane normal to the bottom of the trough.

At the start of the production process, the construction platform is adjusted in such a way that there is a gap between the construction platform and the trough, whose height corresponds to the desired layer thickness of the first substance layer.

In this gap, the dimensionally unstable substance is then subjected to electromagnetic radiation emitted by a source of radiation. This electromagnetic radiation hits the dimensionally unstable substance through the transparent bottom and starts the section-by-section solidification through polymerisation. As a result, a layer consisting of polymerised mass—the substance layer—“grows” from the bottom of the trough up to the construction platform.

Upon completion of the section-by-section solidification, the radiation source is switched off. In order to be able to generate another substance layer on an already existing substance layer, another gap, whose height corresponds to the desired layer thickness of the next substance layer, has to be generated between the bottom of the trough and the already existing substance layer on the construction platform.

To this end, the construction platform is displaced in a plane normal to the bottom of the trough by a predetermined, usually experience-based value in the range of 6-12 mm to ensure a complete detachment of the substance layer from the bottom of the trough.

Once the construction platform has been displaced by the predetermined value, it is lowered again in order to set the desired layer thickness of the next substance layer. After that, the next substance layer can be generated. The number of substance layers depends on the desired layer thickness and the height of the dimensionally stable object to be generated; however, it usually ranges from 50 to 5000.

A problem of this conventional device it that large forces can occur during the detachment process as a result of the cohesive forces between the construction platform and the substance layer and between the bottom of the trough and the substance layer so that the dimensionally stable object is pulled off the construction platform or damaged in some other way.

In order to minimise these arising forces, the bottom of the trough in prior art is made of flexible or partially flexible materials such as silicone layers, PTFE foils or similar. Hence, the bottom of the trough is elastically deformable during the detachment process. As a result of this elastic deformation of the bottom of the trough the substance layer can come off more easily, the necessary detachment force is reduced and, hence, the detachment process is improved. The bottoms of these conventional devices are usually transparent.

As the detachment process is not monitored in the case of conventional devices and as the moment of detachment is thus not detectable, the construction platform has to be displaced by a predetermined, usually experience-based value, for example 6 mm to 12 mm, in a plane normal to the bottom of the trough for detaching the substance layer from the bottom of the trough. It shall thereby be ensured that the substance layer has come off the bottom of the trough safely by the end of the detachment process.

As the single layers have different contours, the adhesive forces vary greatly. It can neither be determined nor ensured when and if the substance layer came off the bottom of the trough. It may therefore happen that the substance layer has already come off the bottom of the trough completely after e.g. half of the pre-set value so that the construction platform travels empty unnecessarily for several millimetres. The detachment process is, therefore, prolonged unnecessarily by several seconds.

Thus, one object of the invention is among others to monitor the detachment process so that the necessary displacement of the construction platform can be optimised by precisely detecting the moment of detachment, which considerably reduces the construction period of a dimensionally stable object. Other objects of the invention are among others the following: determining the filling level of the dimensionally unstable substance in the trough, the deformation of the trough as a result of the lowering of the construction platform, the deformation of the trough as a result of the capillary forces between the construction platform and the bottom of the trough, the slack of the trough, the state of the trough and/or the material of the trough and setting the zero position of the construction platform.

According to the invention, the problems are solved by arranging at least one light source and at least one light sensor detecting the light of the light source in the area of the bottom of the trough in such a way that a deformation of the trough can be detected by the change in the light intensity of the light source detected by the light sensor. In this context, the term light source comprises any detector of electromagnetic radiation and the term light sensor comprises any type of receiver configured to detect this radiation.

In this device according to the invention, the ray of light emitted by the light source passes through the bottom of the trough at least section-wise. Hence, the bottom of the trough forms a light guide, so that in case of changes in the mechanical configuration of the bottom of the trough the light guided therein is deflected or scattered. Deformations of the bottom of the trough therefore change the entry angle of the impinging light so that more of the impinging light leaves the trough compared to an undeformed, straight bottom. This effect, which is known from optical waveguide technology, can therefore be used to detect the mechanical deformation of the bottom of the trough by using the bottom of the trough as a light guide or by providing the bottom of the trough with a light guide.

With this device, the detachment process can thus be monitored and the moment of detachment can be determined precisely. It can thus be ensured that the construction platform is lowered again directly after the detection of the detachment of the substance layer from the bottom of the trough. At usual pull-off speeds of about 1 mm per second the detachment process is thus reduced by several seconds and the construction period of a dimensionally stable object in the device, which is usually made up of 50 to 5000 layers, is thus reduced considerably.

By means of the device according to the invention an expected pull-off force can be calculated as well. A lack thereof indicates that the substance layer has come off the construction platform.

Furthermore, by means of the device according to the invention, the zero position of the construction platform, which at the moment is usually set manually when calibrating the machine, can be determined in an accurately reproducible manner and can thus be set. To this end, the construction platform is lowered and, when in contact with the bottom of the trough, presses it downwards.

Given that the device is able to detect this generated deformation of the trough, the zero position of the construction platform can be determined and set. Also, by accurately setting the zero position of the construction platform, the generated layer thickness of the substance layer corresponds more closely to the set layer thickness.

By means of the device according to the invention the filling level of the dimensionally unstable substance in the trough can be determined and monitored. The filling level may be monitored and determined as the flexible trough can be deformed by gravity depending on the filling level and as this deformation may be detected by means of the device according to the invention. Thus, the formation of one or more dimensionally stable objects can be paused automatically in case the filling level is too low.

Furthermore, by means of the device according to the invention, the deformation can be detected by lowering the construction platform. Once the substance layer has come off, the construction platform has to be lowered again for setting the desired layer thickness (25-200 μm) of the next substance layer. The time needed for lowering the construction platform is called reset time. As a result of the lowering and, thus, the displacing of the dimensionally unstable substance between the construction platform and the bottom of the trough, the bottom of the trough is deformed elastically. The degree of deformation depends among other things on the filling amount and the viscosity of the dimensionally stable substance as well as the lowering speed of the construction platform.

For conventional devices, the time needed for the bottom of the trough to regain its original, undeformed form is at the moment determined on the basis of experience. By means of the device according to the invention, the deformation can now be monitored accurately and, thus, the waiting time between the lowering of the construction platform and the start of the solidification may be reduced and the entire construction period of a dimensionally stable object may be reduced greatly. By means of the needed reset time, also the viscosity of the dimensionally unstable substance can be determined at all times.

Furthermore, by means of the device according to the invention, the deformation caused by capillary forces between the construction platform and the bottom of the trough can be detected.

It is thus possible to detect the deformation by means of the device according to the invention and, thus, to reduce the waiting time between the lowering of the construction platform and the start of the solidification and to reduce the entire time needed to construct a dimensionally stable object.

Furthermore, the slack of the trough, which is caused by the ageing and the wear thereof, can be detected by means of the device according to the invention. Thus, the problems caused by that, such as different layer thicknesses and adhesion problems of the substance layer, can for example be avoided by replacing the trough if the slack is too great.

By means of the device according to the invention, the state of the trough can be detected as well. By diffusion of different components of the dimensionally unstable substance into the trough, the quality of the trough changes. As the substances diffusing into the trough often cause the trough to become clouded, the quality of the trough can be monitored by means of the device according to the invention.

Furthermore, the trough material used can be detected by means of the device according to the invention, as different trough materials usually have different optical densities, which lead to different total reflection angles at the boundary surface.

The invention may provide that at least the bottom of the trough is made partially or completely of a light-conducting material.

The invention may provide that a light guide guiding the ray of light of the light source, for example in the form of an optical fibre line, is provided and preferably arranged in the bottom of the trough.

The invention may provide that the light source is realized as a laser, LED or similar or that it comprises such elements.

The invention may provide that the light sensor comprises at least one photosensitive element, in particular a photodiode with a transimpedance converter as amplifier, which detects the intensity of the light emitted by the light source and converts it into an electrical signal.

The invention may provide that an optical element, preferably a mirror, a prism or similar, is provided for deflecting the light emitted by the light source. Thereby, the light sensor and the light source can be easily incorporated into the machine without disturbing the outward appearance of it and without changing the machine's dimensions.

The invention may provide that at least one optical element, preferably a convex lens, is provided preferably on at least one light sensor for focussing the light emitted by the light source.

The invention may provide that the device is configured to detect the detachment process of the substance layer from the bottom of the trough and/or the construction platform.

The invention may provide that the bottom of the trough is made of flexible and/or partially solid materials, preferably of silicone layers, PTFE foils or similar, whereby the trough is elastically deformable when solidified substance layers are lifted from it. As a result of this flexibility of the trough the substance layer can more easily come off the bottom of the trough, the necessary detachment force is reduced and the detachment process is thus improved.

The bottom of the trough can in particular comprise combinations of substantially rigid and elastic or viscous materials, for example in the form of a sandwich structure: Glass plate on silicone foil, acrylic glass plate on silicone foil, glass plate on silicone plate, glass on highly viscous gel or other combinations.

It can particularly be provided that the deformation of the trough is not exclusively measurable in the particularly elastic layer, but, for example, also in the deformation of the substantially rigid material, for example a plate of Plexiglas.

The invention may provide that the bottom of the trough is realized at least partially transparent in the spectrum of the light emitted by the light source.

The invention may provide that the device comprises at least one analog-to-digital converter, whereby the signal can be processed with the aid of a computer.

The invention may provide that the construction platform can be displaced in a plane normal to the bottom of the trough.

The invention also relates to a method for detecting the mechanical deformation of a trough for receiving a dimensionally unstable substance, in particular one that can be hardened by light, in a device for forming dimensionally stable objects, wherein according to the invention a light emitted by a light source and guided through the trough or a light guide arranged in the trough is detected by a light sensor.

The invention may provide that the mechanical deformation of the trough is determined in case the detected light intensity deviates from a predetermined target value. Based on this, it can according to the invention also be determined if there even is material in the trough and/or what type of material there is in the trough. Furthermore, the detachment process can be monitored according to the invention and it can be determined when the substance layer comes off the trough.

The invention may also provide that the viscosity of the material inside the trough is determined on the basis of the reset time of the construction platform.

Further features according to the invention will become apparent from the claims, the description of the exemplary embodiments and the figures. The invention is now explained in more detail on the basis of non-limiting exemplary embodiments:

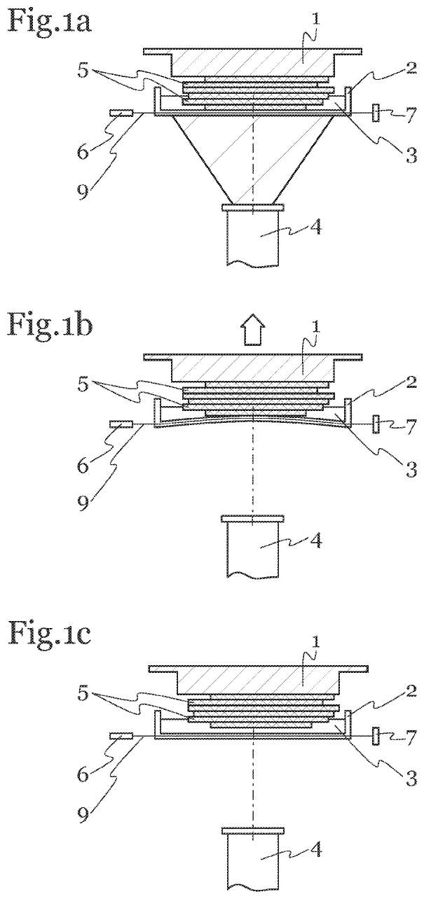

FIG. 1a shows a schematic view of a first embodiment of a device according to the invention in a two-dimensional sectional view. In this embodiment, the bottom of the trough 2 serves as a light guide, which guides the ray of light 9 of the light source 6.

The trough 2 contains the dimensionally unstable substance 3, for example a resin. The construction platform 1 is arranged parallel to the bottom of the trough 2 and can be displaced in a plane normal to the bottom of the trough 2. In this figure it is shown how a substance layer 5 is formed out the dimensionally unstable substance 3 through exposure to electromagnetic radiation from the radiator 4. In the area of the bottom of the trough 2, a light source 6 and a light sensor 7 detecting the light of the light source 6 are arranged in such a way that a deformation of the trough 2 causes a change in the light intensity of the light source 6 detected by the light sensor 7. The light source 6 is arranged on one side of the bottom of the trough and the light sensor 7 is arranged on the other side of it.

FIG. 1b shows the situation in which the solidification of the substance layer 5 has been completed by the radiator 4. In order to detach the substance layer 5 from the bottom of the trough 2, the construction platform 1 is displaced upwards in a plane normal to the bottom of the trough 2. As a result of the cohesive forces between the construction platform 1 and the substance layer 5 and between the bottom of the trough 2 and the substance layer 5 generated during the generation of the substance layer 5, the trough 2 becomes elastically deformed during the displacement of the construction platform 1. As a result of the elastic deformation of the trough 2, part of the ray of light sent through the bottom of the trough is deflected and the light sensor 7 receives a lower light intensity as would be the case in the undeformed state of the trough 2.

FIG. 1c shows the situation in which the detachment process of the substance layer 5 from the bottom of the trough 2 has been completed. There is no exposure to electromagnetic radiation from the radiator 4.

For setting the desired layer thickness for the next substance layer 5, the construction platform 1 containing the different substance layers 5 is being lowered in a plane normal to the bottom of the trough 2 and stops once the desired distance to the bottom of the trough is reached.

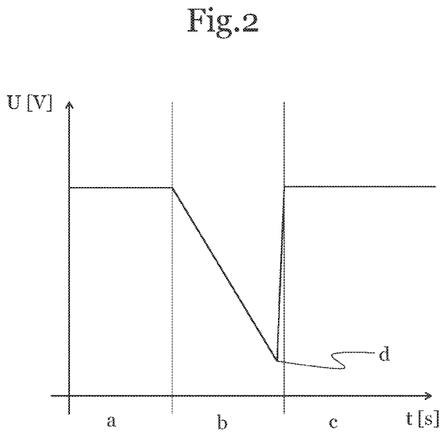

FIG. 2 schematically shows a diagram presenting the voltage U [V] measured at the light sensor 7 with respect to the time t [s] of the previous FIGS. 1a to c. In sub-section a of the diagram the signal is shown at the light sensor 7 of FIG. 1a. It can hereby be seen that the light intensity of the light source 6 detected by the light sensor 7 is within a constant target value range if the trough 2 is not elastically deformed.

In sub-section b it can be seen that a change of the light intensity of the light source 6 detected by the light sensor 7 and, thus, of the measured voltage is caused by the elastic deformation of the trough 2. As a result of the deformation of the trough 2, the light intensity of the light source 6 detected by the light sensor 7 decreases steadily until the moment of detachment (d). Once the substance layer 5 has come off the bottom of the trough 2, the light intensity of the light source 6 detected at the light sensor 7 rises again to its original value and is again within the target value range. In sub-section c the substance layer 5 has come off the bottom of the trough 2 again and the trough 2 is not elastically deformed so that the light intensity of the light source 6 detected by the light sensor 7 is within a target value range again.

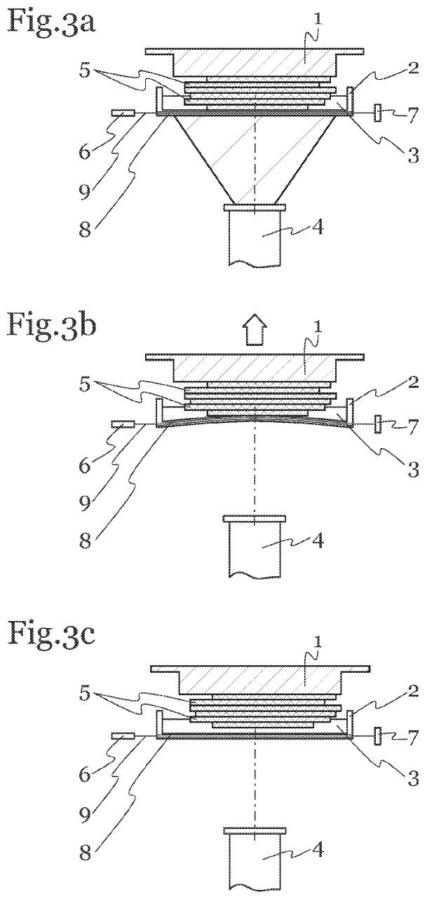

FIG. 3a shows a schematic view of a second embodiment of a device according to the invention in a two-dimensional sectional view. In this embodiment a flexible light guide 8, which guides the ray of light 9 of the light source 6, is arranged in the bottom of the trough 2. The light guide 8 is an optical waveguide, for example an optical fibre line. The trough 2 contains the dimensionally unstable substance 3.

The construction platform 1 in turn is arranged parallel to the bottom of the trough 2 and can be displaced in a plane normal to the bottom of the trough 2.

A substance layer 5 is generated out of the dimensionally unstable substance 3 through exposure to electromagnetic radiation from the radiator 4. In the area of the bottom of the trough 2, a light source 6 is arranged on one side and a light sensor 7 detecting the light of the light source 6 is arranged on the opposite side so that a deformation of the trough 2 causes a change in the light intensity of the light source 6 detected by the light sensor 7.

In an embodiment that is not shown, the light source 6 and/or the light sensor 7 are arranged immediately adjacent to the bottom of the trough 2.

In another embodiment that is not shown, the light source 6 and/or the light sensor 7 are incorporated into the bottom of the trough 2.

FIG. 3b in turn shows the situation in which the forming of the substance layer 5 through exposure to electromagnetic radiation from the radiator 4 has been completed. In order to detach the substance layer 5 from the bottom of the trough 2, the construction platform 1 is displaced in a plane normal to the bottom of the trough 2. As a result of the cohesive forces between the construction platform 1 and the substance layer 5 and between the bottom of the trough 2 and the substance layer 5 generated during the generation of the substance layer 5, the trough 2 containing the dimensionally unstable substance 3 becomes elastically deformed during the displacement of the construction platform 1. As a result, the light guide 8 incorporated in the bottom of the trough 2 is elastically deformed as well.

As a result of the bending of the light guide 8, the entry angle of the impinging light changes so that part of the impinging light leaves the light guide 8. The light intensity measured at the light sensor 7 is thus lower than in the undeformed state.

FIG. 3c in turn shows the situation in which the detachment process of the substance layer 5 from the bottom of the trough 2 has been completed. There is no exposure to electromagnetic radiation from the radiator 4. For setting the desired layer thickness for the next substance layer 5, the construction platform 1 is being lowered in a plane normal to the bottom of the trough 2.

In embodiments of the invention that are not shown, optical elements for deflecting the light emitted by the light source are provided, for example prisms or mirrors. In other embodiments of the invention that are not shown multiple light sources and multiple light sensors are provided and arranged in such a way that a deformation of the trough causes a change in the light intensities of the light sources detected by the light sensors.

In a another embodiment that is not shown, the bottom of the trough itself serves as a light guide and one or more optical waveguides are additionally arranged in the bottom of the trough.

In another embodiment that is not shown, optical elements are provided on a light sensor for focussing the light emitted by the light source, for example optical lenses.

The invention is not limited to the illustrated exemplary embodiments, but rather comprises all devices and methods in the context of the following patent claims.

### REFERENCE LIST

1 Construction platform
2 Trough
3 Dimensionally unstable substance
4 Radiator
5 Substance layer
6 Light source
7 Light sensor
8 Light guide
9 Ray of light

1. Device for forming dimensionally stable objects through section-by-section solidification of a dimensionally unstable substance, in particular one that can be hardened by light, by means of exposure to radiation from a radiator, in particular an electromagnetic radiator, comprising a trough for receiving the substance as well as a construction platform which is arranged above the trough and can be lowered and lifted with respect to the trough for adhering to and lifting solidified substance layers,
wherein
at least one light source and at least one light sensor detecting the light of the light source are arranged in the area of the bottom of the trough in such a way that a deformation of the trough can be detected by changing the light intensity of the light source detected by the light sensor.

2. The device according to claim 1, wherein at least the bottom of the trough is made partially or completely of a light-conducting material.

3. The device according to claim 1, wherein a light guide guiding the ray of light of a light source, for example in the form of an optical fibre line, is provided and preferably arranged in the bottom of the trough.

4. The device according to claim 1, wherein the light source is realized as a laser, LED or similar or that it comprises such elements.

5. The device according to claim 1, wherein the light sensor comprises at least one photosensitive element, in particular a photodiode with a transimpedance converter as amplifier, which detects the intensity of the light emitted by the light source and converts it into an electrical signal.

6. The device according to claim 1, wherein an optical element, preferably a mirror, a prism or similar, is provided for deflecting the light emitted by the light source.

7. The device according to claim 1, wherein at least one optical element, preferably a convex lens, is provided preferably on at least one light sensor for focussing the light emitted by the light source.

8. The device according to claim 1, wherein the device is configured to detect the detachment process of the substance layer from the bottom of the trough and/or from the construction platform.

9. The device according to claim 1, wherein the bottom of the trough is made of flexible and/or partially solid materials, preferably of silicone layers, PTFE foils or similar, whereby the trough is elastically deformable when solidified substance layers are lifted.

10. The device according to claim 1, wherein the bottom of the trough is realized at least partially transparent in the spectrum of the light emitted by the light source.

11. The device according to claim 1, wherein the device comprises at least one analog-to-digital converter, whereby the signal can be processed with the aid of a computer.

12. The device according to claim 1, wherein the construction platform can be displaced in a plane normal to the bottom of the trough.

13. Method for detecting the mechanical deformation of a trough for receiving a dimensionally unstable substance, in particular one that can be hardened by light, in a device for forming dimensionally stable objects, wherein light emitted by a light source and guided through the trough is detected by a light sensor.

14. Method according to claim 13, wherein the mechanical deformation of the trough is determined in case the detected light intensity deviates from a predefined target value.

15. Method according to claim 13, wherein apart from the mechanical deformation the type and/or the amount of the substance in the trough is determined from the detected light intensity.
